(19) United States
(12) Patent Application Publication
(10) Pub. No.: US 2022/0184735 A1
(43) Pub. Date: Jun. 16, 2022

(54) LASER MARKING METHOD AND SCANNING OPTICAL APPARATUS

(71) Applicant: CANON KABUSHIKI KAISHA, Tokyo (JP)

(72) Inventors: Jun Nagatoshi, Tokyo (JP); Ken-ichi Tomita, Shizuoka (JP); Atsushi Sano, Tokyo (JP); Chihiro Shirakawa, Shizuoka (JP); Daisuke Hirata, Gunma (JP); Taro Ebisugi, Saitama (JP)

(21) Appl. No.: 17/541,884

(22) Filed: Dec. 3, 2021

(30) Foreign Application Priority Data
Dec. 11, 2020 (JP) 2020-206265

(51) Int. Cl. B23K 26/082; B23K 26/354

(52) U.S. Cl. CPC B23K 26/0821; B23K 2101/007; B23K 26/354

(57) ABSTRACT

A laser marking method of performing marking by irradiating an object made of a resin with laser light, the laser marking method including: a first step of melting of carbonizing a first region of the object; and a second step of engraving a mark by irradiating a second region in the first region with the laser light.

### BACKGROUND OF THE DISCLOSURE

### Field of the Disclosure

The present disclosure relates to a laser marking method and a scanning optical apparatus. For example, the present disclosure relates to a scanning optical apparatus having a resin subjected to marking through use of a laser.

### Description of the Related Art

In recent years, as a method of managing components and units, there has been known a method of identifying and managing an object by irradiating the object with laser light to subject the object to marking (hereinafter referred to as “laser marking”). In a case in which the object of the laser marking is a resin molded product, when the resin molded product is irradiated with the laser light, the laser light is transmitted through a surface of the resin molded product to heat carbon black in a resin. The heated carbon black heats and melts the peripheral resin, locally decomposes the resin, and generates fine foam (hereinafter referred to as “foaming”) from the inside. Through the foaming, the resin on the surface of the resin molded product is pushed up from the inside, and in general, a whitish protruding portion raised by about 5 μm to about 50 μm is formed. The protruding portion becomes a whitish mark, and becomes visually recognizable (Japanese Patent Application Laid-Open No. H05-092657).

However, even with a resin molded product having a color close to white or a resin molded product having a dark color, the following difficulties occur depending on, for example, molding conditions. That is, in a case in which silver streaks being silver traces caused on the surface have occurred, even when the laser marking is performed, a sufficient contrast between the color of the marked portion and the peripheral color cannot be obtained, and the visibility is lowered.

In addition, a component that requires a highly accurate shape, for example, an optical box of a scanning optical apparatus, is molded by fine foam molding in order to improve dimensional stability. In this case, the fine foam molding is a molding method in which nitrogen or carbon dioxide in a supercritical state is added to a melted resin to form fine air bubbles each having a diameter of 100 μm or less inside a molded product. When the fine foam molding is performed, traces left after the air bubbles generated by the resin flowing in the mold are stretched on the surface of the molded product (hereinafter referred to as “swirl marks”) are caused on the molded product. The color of the surface of the molded product on which the swirl marks have been caused does not exhibit a sufficient contrast with respect to the color of the portion marked by the laser marking. There is also a concern in that, when a one-dimensional or two-dimensional bar code is marked under a state in which a sufficient contrast cannot be obtained by the laser marking, the bar code may fail to be stably read by a reader.

### SUMMARY OF THE DISCLOSURE

The present disclosure has been made under such circumstances, and has an objective to provide laser marking with satisfactory visibility irrespective of a surface state of a resin molded product.

In order to solve the above-mentioned disadvantage, according to the present disclosure, there is provided a laser marking method of performing marking by irradiating an object made of a resin with laser light, the laser marking method comprising: a first step of melting or carbonizing a first region of the object; and a second step of engraving a mark by irradiating a second region in the first region with the laser light.

According to the present disclosure, there is provided a scanning optical apparatus configured to form an electrostatic latent image by irradiating a photosensitive member with laser light, the scanning optical apparatus comprising: a casing of which at least one portion is formed of a resin; a first region which is melted or carbonized in the at least one portion formed of the resin; and a second region subjected to engraving processing in the first region.

Further features of the present disclosure will become apparent from the following description of exemplary embodiments with reference to the attached drawings.

### BRIEF DESCRIPTION OF THE DRAWINGS

FIG. 1 is a view for illustrating a principle of laser marking in each of a first embodiment, a second embodiment, and a third embodiment.

FIG. 2A and FIG. 2B are views for illustrating a first step and a second step of a laser marking method according to the first embodiment.

FIG. 3 is a perspective view for illustrating a configuration of a scanning optical apparatus according to the first embodiment.

FIG. 4A and FIG. 4B are views for illustrating a first step and a second step of a laser marking method according to the second embodiment.

FIG. 5 is a view for illustrating a laser marking method according to the third embodiment.

FIG. 6 is a view for illustrating a configuration of an image forming apparatus in a fourth embodiment.

### DESCRIPTION OF THE EMBODIMENTS

Now, a laser marking method according to each of embodiments of the present disclosure and a scanning optical apparatus including a resin component subjected to marking by the laser marking method are described. In the following description, like components are denoted by like reference symbols.

### First Embodiment

### Principle of Marking

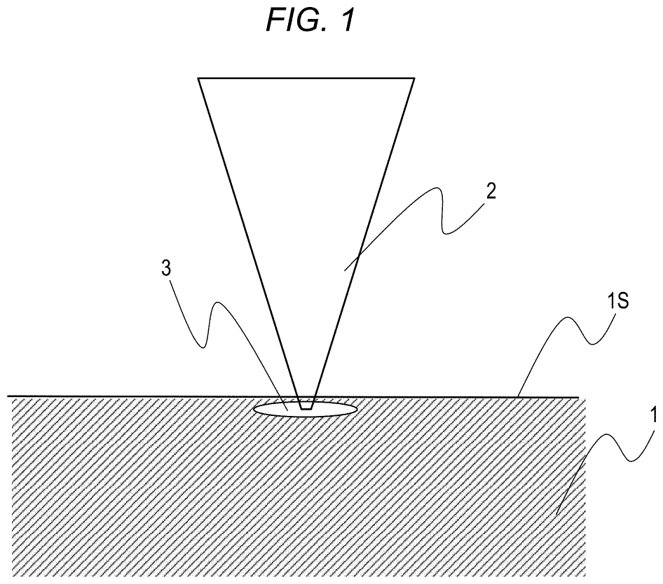

FIG. 1 is a view for illustrating a principle of marking of a laser marking method according to a first embodiment. An object to be subjected to laser marking is molded from a resin, and the object is hereinafter referred to as “resin 1.” FIG. 1 is a cross-sectional view of the resin 1. The laser marking is provided by a laser light 2 applied from a laser marking apparatus (not shown). The laser light 2 irradiates an inner region in the resin 1 (hereinafter referred to as “resin inside portion”) 3. As the laser light 2, for example, a fiber laser having a wavelength of 1,062 nm is used. When the resin 1 is irradiated with the laser light 2, the laser light 2 is transmitted through a surface 1S of the resin 1 to heat the resin inside portion 3. The resin 1 heated in the resin inside portion 3 is locally decomposed to generate fine foam (hereinafter referred to as “foaming”) in the inside portion. Due to the foaming, a portion irradiated with the laser light 2 becomes lighter in color than its periphery (portion that has not been irradiated with the laser light 2, or portion that has not caused the foaming). Accordingly, the portion irradiated with the laser light 2 becomes a visually recognizable mark due to a color contrast with respect to its periphery.

In the following description, the laser marking apparatus (not shown) includes a laser irradiation device (not shown) configured to apply the laser light 2 and a controller (not shown) configured to control the laser irradiation device. The controller (not shown) of the laser marking apparatus (not shown) includes, for example, a CPU, a ROM, and a RAM, and controls a laser marking operation of the laser marking apparatus in accordance with a program stored in the ROM while using the RAM as a temporary work area. Accordingly, the controller (not shown) also controls, for example, an output (W) and a moving direction (scanning direction) of the laser irradiation device (not shown) when the laser light is applied therefrom. In regard to the movement of the laser light, the laser irradiation device may be configured to move, or the object may be configured to move.

### Laser Marking Method

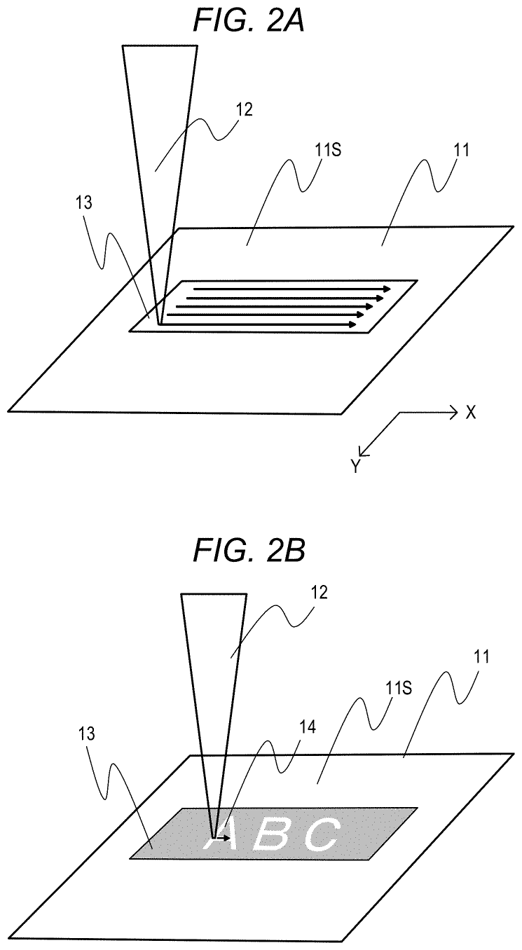

With reference to FIG. 2A and FIG. 2B, a laser marking method according to the first embodiment is described. The laser marking method according to the first embodiment is formed mainly of two steps. A first step is a step of melting a surface of a resin with laser light to expose a background. A second step is a step of performing laser marking by again applying the laser light within a region melted by the irradiation of the laser light.

### First Step

With reference to FIG. 2A, the first step of melting the surface of a resin through use of laser light to expose the background is described. A resin 11 is irradiated with a laser light 12 from the laser marking apparatus (not shown). In this case, the laser light 12 melts a first region (hereinafter referred to simply as “region”) 13 in a surface 11S of the resin 11. The region 13 is a two-dimensional region having a predetermined area. The laser light 12 is applied by being moved in the X direction at a predetermined position in the Y direction of FIG. 2A. In FIG. 2A, the moving direction of the laser light 12 in the X direction in the region 13 is indicated by a plurality of arrows. When the irradiation in the X direction in the region 13 at the predetermined position in the Y direction is ended, the laser light 12 is applied by being moved from the predetermined position to another predetermined position in the Y direction and moved in the X direction at the another predetermined position in the Y direction. For example, with such a method, the laser marking apparatus melts the surface of the resin 11 by two-dimensionally scanning the specific region 13 of the resin 11 by the laser light 12 having a first output of, for example, about 20 W (watts). The method of two-dimensionally moving the laser light 12 in the specific region 13 may be any method as long as the inside of the specific region 13 is melted in a two-dimensional manner.

### Second Step

Subsequently, with reference to FIG. 2B, the second step of performing the marking (engraving processing) by again applying the laser light 12 within the region 13 obtained by melting the surface 11S of the resin 11 by the laser light 12 is described. The laser marking apparatus (not shown) subjects a portion 14 being a second region to the marking by applying the laser light 12 within the region 13. For example, the laser marking apparatus applies the laser light 12 having a second output (having, for example, about 4 W) lower than the output of the laser light 12 in the first step within the region 13 obtained by melting the surface 11S of the resin 11 by the laser light 12. As described with reference to FIG. 1, the portion 14 irradiated with the laser light 12 causes foaming inside the resin 11, and becomes lighter in color than its periphery. Through two-dimensional scanning of the laser light 12, the portion 14 irradiated with the laser light 12 can form a protruding shape that is visually recognizable as a mark such as characters of, for example, “A B C.” In this manner, in the second step, a mark is formed in the region irradiated with the laser light 12. In addition, the second output used in the second step is lower than the first output used in the first step.

According to the first embodiment, the laser marking is performed within the region 13 obtained by melting the surface 11S of the resin 11 by the laser light 12. Thus, even when silver streaks or the like are caused on the surface 11S of the resin 11, the laser marking with satisfactory visibility can be stably provided without being affected by a surface state of a resin molded product.

### Scanning Optical Apparatus

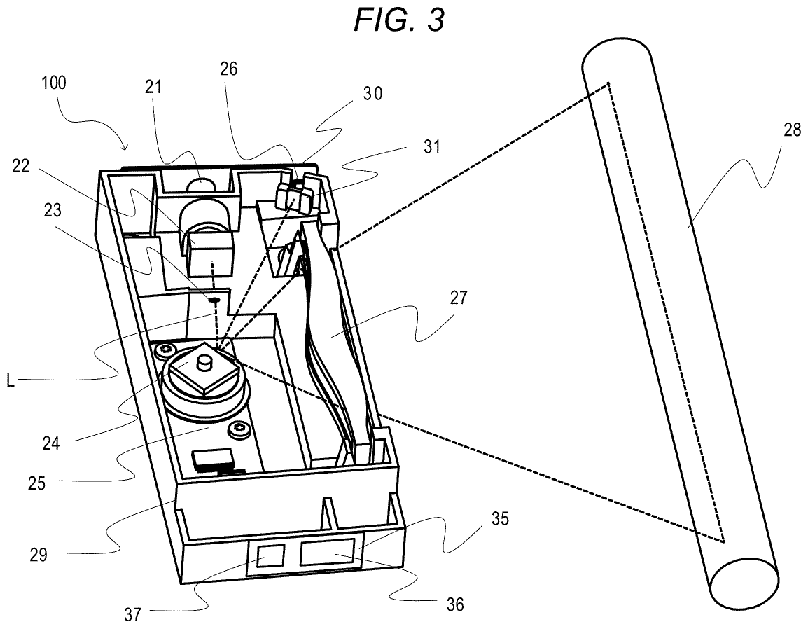

With reference to FIG. 3, a configuration of the scanning optical apparatus 100 subjected to the laser marking by the laser marking method according to the first embodiment is described. FIG. 3 is an explanatory perspective view for illustrating a configuration of the scanning optical apparatus 100. The scanning optical apparatus 100 includes a semiconductor laser unit 21, an anamorphic collimator lens 22, an aperture diaphragm 23, a rotary polygon mirror 24, a light deflector 25, a BD 26, an fθ lens (scanning lens) 27, a BD lens 31, an optical box 29, and a laser circuit board 30. The semiconductor laser unit 21 is a light source configured to emit a laser beam L. The anamorphic collimator lens 22 is a lens having both functions of a collimator lens and a cylindrical lens. The light deflector 25 (scanner motor) drives the rotary polygon mirror 24 to rotate. The BD 26 is a beam detector. When the BD 26 receives the laser beam L, the BD 26 outputs a synchronization signal for determining a writing start position. The fθ lens 27 is a scanning lens configured to guide the laser beam L reflected by the rotary polygon mirror 24 to a scanned surface 28. The BD lens 31 is a lens configured to guide the laser beam L reflected by the rotary polygon mirror 24 to the BD 26. The optical box 29 is a casing configured to store the above-mentioned members, and has at least one portion formed of a resin. The BD 26 is mounted to the laser circuit board 30.

The optical box 29 is a resin molded product molded from a black resin. The optical box 29 is subjected to the laser marking through use of the laser marking method described with reference to FIG. 2A and FIG. 2B. That is, the optical box 29 corresponds to the resin 11 illustrated in FIG. 2A and FIG. 2B. A one-dimensional bar code 36 and a two-dimensional bar code 37 are laser-marked within a region 35 melted by the laser light with which the optical box 29 is irradiated by the laser marking apparatus (not shown). That is, the region 35 is melted by the first step of the laser marking method according to the first embodiment, and the one-dimensional bar code 36 and the two-dimensional bar code 37 are marked by the second step.

The semiconductor laser unit 21 being a light source, the anamorphic collimator lens 22, the light deflector 25, the fθ lens 27 being an imaging member, and the BD lens 31 are fixed to the optical box 29 by, for example, press-fitting, bonding, or screw-fastening. The semiconductor laser unit 21 emits the laser beam L. The anamorphic collimator lens 22 images, as a line image, the laser beam L emitted from the semiconductor laser unit 21 on a reflecting surface of the rotary polygon mirror 24. The rotary polygon mirror 24 is driven to rotate by the light deflector 25, to thereby deflect the laser beam L. Then, the laser beam deflected by the rotary polygon mirror 24 is transmitted through the fθ lens 27, to thereby be imaged and scanned on the scanned surface 28 (for example, the surface of a photosensitive drum being a photosensitive member).

In order to stably image the laser beam L on the scanned surface 28 of, for example, the photosensitive drum, it is required to maintain the positions and postures of the anamorphic collimator lens 22 and the fθ lens 27 with high accuracy. Accordingly, dimensional errors in the optical box 29 at portions relating to the positioning of optical elements including the anamorphic collimator lens 22 and the fθ lens 27 are required to be suppressed to or less than a range of from 10 μm to 30 μm.

For dimensional stability, fine foam molding is used for molding the optical box 29. When the fine foam molding is performed, swirl marks occur in a molded product. The swirl marks are traces left after air bubbles generated at the tip of a flowing resin are stretched on the surface of the molded product. Unless the object is an exterior component, the swirl marks are considered to exert no influences on performance, but when the laser marking is performed, the marked portion often fails to exhibit a sufficient contrast with respect to its periphery. Accordingly, as described with reference to FIG. 2A and FIG. 2B, the surface of the optical box 29 is melted by scanning the region 35 by the laser light of about 20 W in the first step of the laser marking method according to the first embodiment, to thereby be able to remove the swirl marks. After that, by the second step of the laser marking method according to the first embodiment, the one-dimensional bar code 36 and the two-dimensional bar code 37 are laser-marked on the surface in the region 35 of the optical box 29 having no swirl marks.

In addition, in order to reduce the influences of vibration strength and thermal expansion, a resin mixed with an inorganic reinforcing material including glass fiber, glass beads, mica, or carbon fiber is used as the material of the optical box 29. In this case as well, with related-art laser marking methods, a substance mixed into the surface of the molded product may be raised to cause a portion with a non-uniform color tone, and hence a sufficient contrast may not be obtained. To deal with this issue as well, as described with reference to FIG. 2A and FIG. 2B, the surface of the optical box 29 is melted by scanning the region 35 by the laser light of about 20 W in the first step of the laser marking method according to the first embodiment, to thereby enable the color tone to become uniform. After that, in the second step of the laser marking method according to the first embodiment, the one-dimensional bar code 36 and the two-dimensional bar code 37 are laser-marked on the surface in the region 35 of the optical box 29 having the uniform color tone. In addition, when the marking is to be performed on a weld portion of the molded product or a portion in which gas traces appear, it is possible to obtain the same effect by carrying out the first step and the second step of the laser marking method according to the first embodiment.

The one-dimensional barcode 36 includes at least one piece of information including, for example, a component number, a component molding date, a production lot, a stratification of a component manufacturer or a material, a serial number, and a production place. Meanwhile, the two-dimensional bar code 37 includes, for example, optical performance data measured by a step of assembling the scanning optical apparatus 100. When the scanning optical apparatus 100 images and scans the laser beam L, it is possible to improve the optical performance by performing, for example, electrical correction based on the above-mentioned information. The information included in the one-dimensional bar code 36 and the two-dimensional bar code 37 may be other information.

In this manner, the laser marking method according to the first embodiment is carried out on the optical box 29. Thus, even in an optical box using a resin subjected to fine foam molding or mixed with an inorganic reinforcing material, a one-dimensional bar code or a two-dimensional bar code that can be stably read by a reader can be laser-marked without being affected by a surface state of the resin. The first embodiment has been described by taking the one-dimensional bar code and the two-dimensional bar code as an example of indications relating to the unit (optical box 29) of the scanning optical apparatus 100, but a number, a character, or other information may be used. The mark includes a one-dimensional bar code, a two-dimensional bar code, a number, and a character, and serves to indicate information relating to the component on which the mark is formed.

Further, the type, wavelength, and output value of the laser light for the laser marking described as an example in the first embodiment are merely examples, and the present disclosure is not limited thereto.

Further, the optical box 29 is subjected to the marking in the first embodiment, but the same effect can be obtained when the marking is performed on a lid (not shown) of the optical box 29 or the semiconductor laser unit 21. That is, a place on which the laser marking method according to the first embodiment is performed may be any portion molded with a resin.

As described above, according to the first embodiment, the laser marking with satisfactory visibility can be provided irrespective of the surface state of the resin molded product.

### Second Embodiment

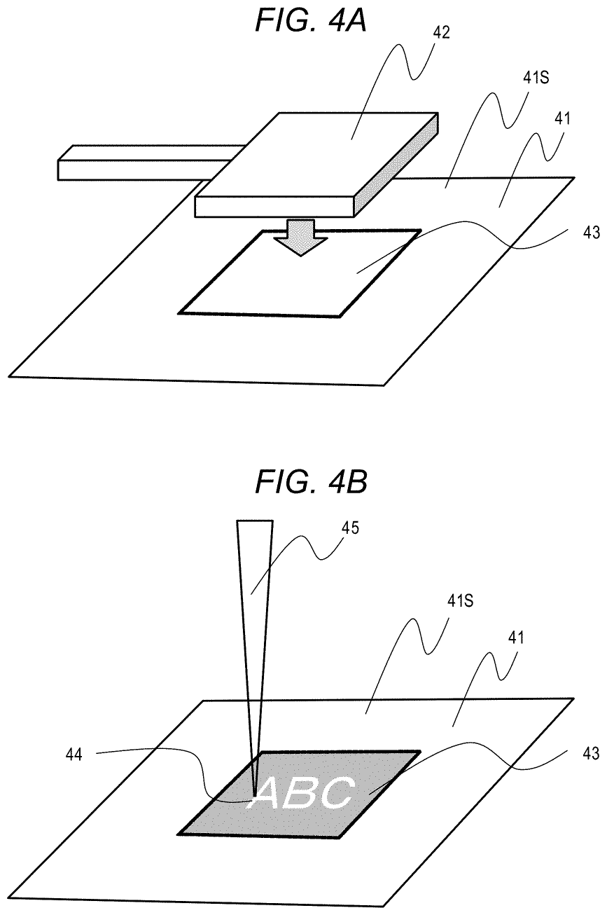

With reference to FIG. 4A and FIG. 4B, a laser marking method according to a second embodiment is described. The laser marking method according to the second embodiment is also formed mainly of two steps. The first step is a step of carbonizing the surface of a resin by a heater. The second step is a step of performing marking by applying laser light within a region in the surface of the resin, which has been carbonized by the heater.

In the following description, it is assumed that an apparatus (not shown) including the heater includes a controller (not shown) configured to control the heater. It is assumed that the controller (not shown) of the apparatus (not shown) including the heater includes, for example, a CPU, a ROM, and a RAM, and controls the apparatus (not shown) including the heater in accordance with a program stored in the ROM while using the RAM as a temporary work area. Accordingly, the controller (not shown) also controls, for example, a temperature of the heater, a heating time, and movement of the heater.

### First Step

With reference to FIG. 4A, the first step of carbonizing the surface of the resin by the heater having a predetermined area is described. The heater 42 is moved in a direction indicated by the arrow illustrated in FIG. 4A to be brought into contact with a specific region 43 being a first region in a surface 41S of a resin 41, and performs heating on the specific region 43 at about 150° C. for, for example, about 5 seconds. Thus, the specific region 43 of the resin 41 heated by the heater 42 is carbonized, and becomes black. The time and temperature for the heating performed by the heater 42 may be appropriately set depending on the resin 41 being the object.

### Second Step

Subsequently, with reference to FIG. 4B, the second step of performing the marking by applying the laser light within the region 43 carbonized by the heater 42 is described. When the region 43 carbonized by the heater 42 is irradiated with a laser light 45 by the laser marking apparatus (not shown), the portion irradiated with the laser light 45 becomes lighter in color in accordance with the principle described with reference to FIG. 1, to thereby be able to perform the marking of a mark 44 serving as a second region. In the same manner as in the second step in the first embodiment, the laser light 45 (having, for example, an output of 4 W) is two-dimensionally scanned, to thereby perform the marking of characters of, for example, “A B C.” When the laser marking is performed on the region 43 having the surface of the resin carbonized, the laser marking with satisfactory visibility can be stably provided without being affected by, for example, the color of the resin in the same manner as in the first embodiment.

As described above, according to the second embodiment, the laser marking with satisfactory visibility can be provided irrespective of the surface state of the resin molded product.

### Third Embodiment

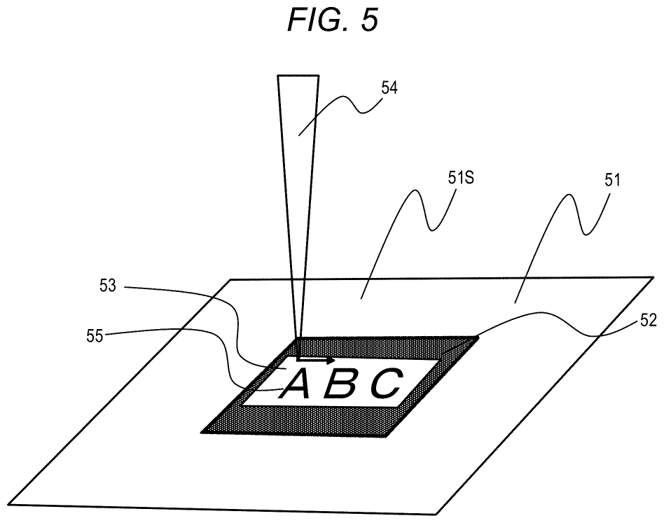

In the first embodiment and the second embodiment, high-power laser light and a heater are applied to create a region having a color close to black, and the marking is performed by whitening a resin with low-power laser light in the created region as illustrated in FIG. 2B and FIG. 4B, respectively. Meanwhile, in the created region having the color close to black, the mark to be displayed may be raised in black by having the periphery of the mark irradiated with the laser light to be whitened. A step thereof is described with reference to FIG. 5.

FIG. 5 is a view for illustrating a second step of a laser marking method according to a third embodiment. The first step of the laser marking method according to the third embodiment is the same as the first step in the first embodiment or the second embodiment. The high-power laser light (having an output of, for example, about 20 W) irradiates a surface 51S of a resin 51 to melt the surface 51S of the resin 51, or the surface 51S of the resin 51 is carbonized by a heater (not shown) to cause a first region (hereinafter referred to simply as “region”) 52 to become black. The laser marking apparatus (not shown) scans a laser light 54 over a second region (hereinafter referred to simply as “region”) 53 in the region 52 with an output of, for example, about 4 W. At that time, only a mark 55 being a portion to be displayed is not irradiated with the laser light, to thereby cause the periphery of the mark 55 to become white with only the mark 55 remaining black. The marking can also be performed by avoiding irradiating the mark 55 with the laser light 54 in this manner. In the second step in the third embodiment, the mark is formed in the region that has not been irradiated with the laser light.

In such a manner, the laser marking can be performed so that the mark becomes darker than the peripheral color. When an area of the mark 55 such as a two-dimensional bar code is large, it is possible to shorten a time period required for the laser marking by performing the laser marking in the third embodiment.

It is also to be understood that the laser marking methods according to the second embodiment and the third embodiment can be applied to the scanning optical apparatus as described in the first embodiment.

It is further to be understood that the present disclosure can be adapted not only to the scanning optical apparatus but also to a component or unit using a resin.

As described above, according to the third embodiment, the laser marking with satisfactory visibility can be provided irrespective of the surface state of the resin molded product.

### Fourth Embodiment

### Description of Laser Beam Printer

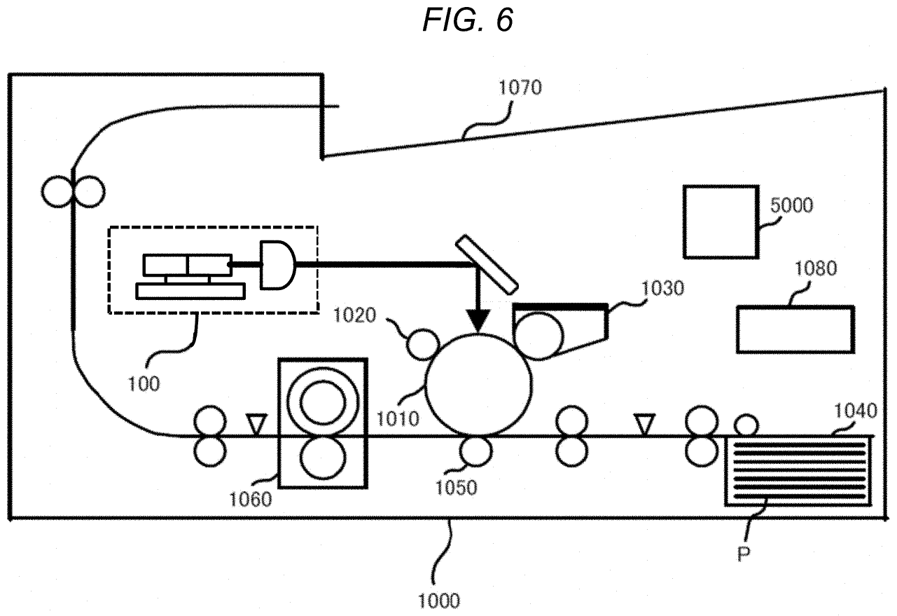

In FIG. 6, a schematic configuration of a laser beam printer is illustrated as an example of an image forming apparatus. A laser beam printer 1000 (hereinafter referred to as “printer 1000”) includes a photosensitive drum 1010 being a member to be scanned, a charger 1020, and a developing device 1030. The photosensitive drum 1010 is an image bearing member on which an electrostatic latent image is to be formed. The charger 1020 uniformly charges the photosensitive drum 1010. The scanning optical apparatus 100 being an exposure unit scans laser light corresponding to image data on the photosensitive drum 1010, to thereby form an electrostatic latent image. The scanning optical apparatus 100 has the configuration described with reference to FIG. 3. The optical box 29 of the scanning optical apparatus 100 has the region 35 melted by the first step of the laser marking methods described in the first to third embodiments, and the one-dimensional bar code 36 and the two-dimensional bar code 37 are marked by the second step.

The developing device 1030 develops the electrostatic latent image formed on the photosensitive drum 1010 with toner, to thereby form a toner image. The toner image formed on the photosensitive drum 1010 (on the image bearing member) is transferred, by a transfer device 1050, onto a sheet P serving as a recording material supplied from a cassette 1040, and the unfixed toner image transferred onto the sheet P is fixed by a fixing device 1060 to be delivered to a tray 1070. The photosensitive drum 1010, the charger 1020, the developing device 1030, and the transfer device 1050 constitute an image forming unit. The printer 1000 also includes a power supply apparatus 1080, and supplies electric power from the power supply apparatus 1080 to a controller 5000 and a driver, for example, a motor. The controller 5000 includes a CPU (not shown), and controls, for example, an image forming operation performed by the image forming unit and a conveying operation for the sheet P. The image forming apparatus to which the scanning optical apparatus 100 including the optical box 29 subjected to the marking by the laser marking method according to the present disclosure can be applied is not limited to the image forming apparatus having the configuration illustrated in FIG. 6.

As described above, according to the fourth embodiment, the laser marking with satisfactory visibility can be provided irrespective of the surface state of the resin molded product.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-206265, filed Dec. 11, 2020, which is hereby incorporated by reference herein in its entirety.

What is claimed is:

1. A laser marking method of performing marking by irradiating an object made of a resin with laser light, the laser marking method comprising:
a first step of melting or carbonizing a first region of the object; and
a second step of engraving a mark by irradiating a second region in the first region with the laser light.

2. The laser marking method according to claim 1, wherein the first step includes irradiating the first region with the laser light to melt the first region.

3. The laser marking method according to claim 1, wherein the first step includes irradiating the first region with the laser light at a first output, and wherein the second step includes irradiating the second region with the laser light at a second output lower than the first output.

4. The laser marking method according to claim 1, wherein the first step includes carbonizing the first region by heat from a heater.

5. The laser marking method according to claim 1, wherein the second step includes engraving the mark in a portion irradiated with the laser light in the second region.

6. The laser marking method according to claim 1, wherein the second step includes engraving the mark in a portion other than a portion irradiated with the laser light in the second region.

7. The laser marking method according to claim 1, wherein the resin is mixed with an inorganic reinforcing material including glass, mica, or carbon fiber.

8. The laser marking method according to claim 7, wherein the object is molded by foam molding.

9. The laser marking method according to claim 1, wherein the object is a casing of a scanning optical apparatus configured to form an electrostatic latent image by irradiating a member to be scanned with laser light.

10. The laser marking method according to claim 9, wherein the mark includes at least one of a one-dimensional bar code, a two-dimensional bar code, a number, and a character which include information relating to the scanning optical apparatus.

11. A scanning optical apparatus configured to form an electrostatic latent image by irradiating a photosensitive member with laser light, the scanning optical apparatus comprising:
a casing of which at least one portion is formed of a resin;
a first region which is melted or carbonized in the at least one portion formed of the resin; and
a second region subjected to engraving processing in the first region.

12. The scanning optical apparatus according to claim 11, wherein the resin is mixed with an inorganic reinforcing material including glass, mica, or carbon fiber.

13. The scanning optical apparatus according to claim 11, wherein the casing is molded by foam molding.

14. The scanning optical apparatus according to claim 11, wherein a mark representing information relating to the scanning optical apparatus is formed in the second region by the engraving processing.

15. The scanning optical apparatus according to claim 14, wherein the mark includes at least one of a one-dimensional bar code, a two-dimensional bar code, a number, and a character.
